(19) United States
(12) Patent Application Publication
(10) Pub. No.: US 2024/0411698 A1
(43) Pub. Date: Dec. 12, 2024

(54) ACCUMULATING A TAG CACHE FROM A PROFFERED DATASET

(71) Applicant: Truist Bank, Charlotte, NC (US)

(72) Inventors: Jonathan Randall Howarth, Raleigh, NC (US); Szu Yu Zoe Chao, Cary, NC (US); Brian Stewart Brown, Apex, NC (US); Thomas Prescott Atherton, Atlanta, GA (US); Earlie Clark, IV, Wake Forest, NC (US)

(73) Assignee: Truist Bank, Charlotte, NC (US)

(21) Appl. No.: 18/329,677

(22) Filed: Jun. 6, 2023

(51) Int. Cl. G06F 12/0895

(52) U.S. Cl. CPC G06F 12/0895; G06F 3/0482; G06F 3/04886

(57) ABSTRACT

A tag accumulator tool includes, in an expanded mode, a proffered dataset of items for user selection, and a displayed accumulation area including a tag cache having, for each one of the selected data items, a respective corresponding tag. In a reduced mode, the tag accumulator tool displays an enumeration of the selected data items. A query box is operable to, upon entry of a character string, display a redacted list of selectable items including only those items of the proffered dataset at least partially matching the character string. Each tag in the accumulation area may include an annul tool the activation of which removes the tag from the accumulation area, effectively returning the corresponding data item to an unselected status.

### TECHNICAL FIELD

The present disclosure relates to tools for listing data items and permitting their selection for further processing, searching, or other use. More particularly, the present disclosure relates to a tag accumulator by which items in a list are easily found, selected, enumerated, and accumulated.

### BACKGROUND

Computer users, with reference to users of desktop units, laptops, public kiosks, and mobile phones, are accustomed to making selections from displayed lists. Users are accustomed to scrolling lists and making selections of listed items by clicking items or otherwise indicating their choices. In some instances, lists can be lengthy, exceeding any number feasibly visible at once on one display. In other instances, selected items may be non-adjacent and/or disparate even in a list that can be wholly displayed.

Online activities such as purchases, payments, and billings are increasingly intended and expected to be conducted with convenience and with as few keystrokes and as little searching as feasible, particularly when small devices are used, such as mobile phones. Thus, as ever before and perhaps even more so when a few clicks can authorize considerable payments or other activities, certainty in what selections have been made from a list is of utmost importance.

Improvements are needed to enable users to navigate and utilize lists, to inform users of what selections are available, to conveniently indicate what selections have been made, and to generally streamline the use and searching of dropdown lists.

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

According to at least one embodiment, a computing device accumulates a tag cache from a proffered dataset. The computing device includes at least one processor, a communication interface communicatively coupled to the at least one processor, and a memory device storing executable code that, when executed, causes the processor to: initiate a tag accumulator tool by at least displaying, in an expanded mode of the tag accumulator tool, a proffered dataset comprising multiple data items; receive user input selecting one or more of the multiple data items; display an accumulation area comprising a tag cache comprising, for each one of the selected data items, a respective corresponding tag; and display, in at least a reduced mode of the tag accumulator tool, an enumeration of the selected data items.

In the expanded mode of the tag accumulator tool and in the reduced mode of the tag accumulator tool, a display of the tag accumulator tool may include a query box operable to, upon entry of a character string into the query box, display a redacted list of selectable items, the redacted list of selectable items including only those multiple data items of the proffered dataset at least partially matching the character string.

In the expanded mode of the tag accumulator tool and in the reduced mode of the tag accumulator tool, the display of the tag accumulator tool may include an operable toggle indicium, by which, upon user action thereon, the display of the tag accumulator transitions between the expanded mode and the reduced mode.

A design system token may be used to initiate display of the tag accumulator tool.

The design system token may be compatible with a screen reader for outputting to a speech synthesizer or braille display.

In some examples, each respective corresponding tag includes an annul tool the activation of which removes the respective corresponding tag from the accumulation area.

The proffered dataset may include multiple displayed data items and additional data items displayed upon use of a scroll tool.

In at least one embodiment, to which the above examples apply as well, a system accumulates a tag cache from a proffered dataset. The system includes at least one processor, a communication interface communicatively coupled to the at least one processor, and a memory device storing executable code that, when executed, causes the processor to: transmit to a user device instructions to initiate a tag accumulator tool by at least displaying, in an expanded mode of the tag accumulator tool, a proffered dataset comprising multiple data items; receive, from the user device, input selecting one or more of the multiple data items; transmit to the user device instructions to display an accumulation area comprising a tag cache comprising, for each one of the selected data items, a respective corresponding tag; and transmit to the user device instructions to display, in at least a reduced mode of the tag accumulator tool, an enumeration of the selected data items.

In yet another embodiment, to which the above examples also apply as well, a method for a computing system to accumulate a tag cache from a proffered dataset is provided. The computing system includes one or more processor, and at least one memory device storing computer-readable instructions, the one or more processor configured to execute the computer-readable instructions. The method includes, upon execution of the computer-readable instructions: initiating a tag accumulator tool by at least displaying, in an expanded mode of the tag accumulator tool, a proffered dataset comprising multiple data items; receiving user input selecting one or more of the multiple data items; displaying an accumulation area comprising a tag cache comprising, for each one of the selected data items, a respective corresponding tag; and displaying, in at least a reduced mode of the tag accumulator tool, an enumeration of the selected data items.

The above summary is to be understood as cumulative and inclusive. The above described embodiments and features are combined in various combinations in whole or in part in one or more other embodiments.

### BRIEF DESCRIPTION OF THE DRAWINGS

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1 illustrates an enterprise system and environment thereof, in accordance with various embodiments of the present invention.

FIG. 2 shows a display of an accumulator tool according to at least one embodiment.

FIG. 3 shows the accumulator tool of FIG. 2, and accumulation area thereof, shown in an expanded mode of the accumulator tool.

FIG. 4 shows the accumulator tool as in FIG. 3, shown with additionally selected items for illustration of function of the accumulator tool.

FIG. 5 shows the accumulator tool as in FIG. 4, with an enumeration of selected items, in the expanded mode of the accumulator tool.

FIG. 6 shows the accumulator tool as in FIG. 4, with an enumeration of selected items, in a reduced mode of the accumulator tool.

FIG. 7 shows the accumulator tool of FIG. 1, with a scroll tool for navigation of a lengthy proffered dataset listed.

FIG. 8 shows the accumulator tool as in FIG. 7, with a query box in use and the listed dataset redacted accordingly.

FIG. 9 shows the accumulator tool as in FIG. 8, with an accumulation area including a tag cache, shown in the expanded mode of the accumulator tool.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to illustrations and/or block diagrams of systems and apparatuses (the term “apparatus” includes systems and computer program products), will be understood such that each function described or implied with reference to the illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts described, illustrated, and/or implied.

These computer program instructions may also be stored in a computer-readable memory that can direct a computer or other programmable data processing apparatus to function in a particular manner, such that the instructions stored in the computer readable memory produce an article of manufacture including instructions, which implement the function/act described, illustrated, and/or implied.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts described, illustrated, and/or implied. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein. Where functions of hardware and software are described herein, related methods are detailed therewith, such that methods are disclosed as well.

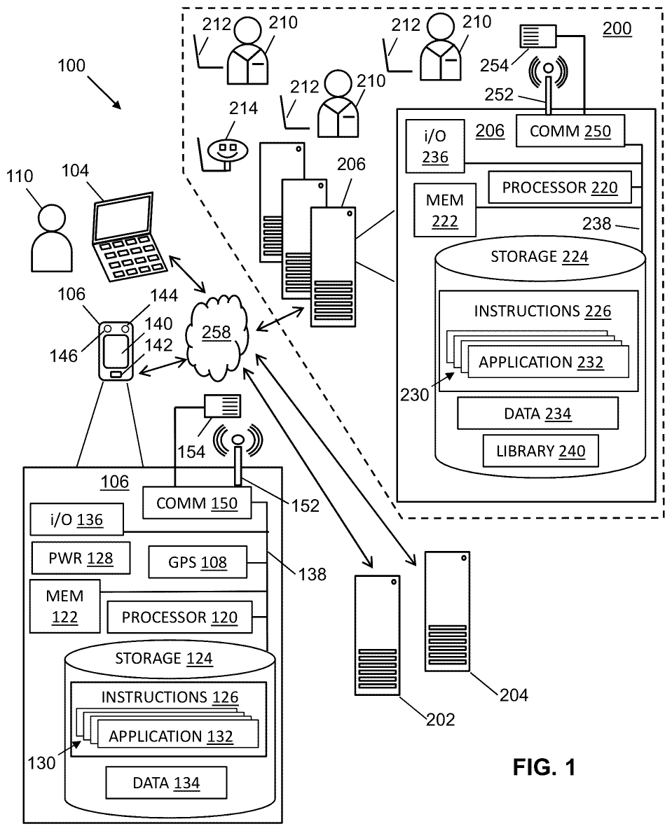

FIG. 1 illustrates a system 100 and environment thereof, according to at least one embodiment, by which a user 110 benefits through use of services and products of an enterprise system 200. The environment may include, for example, a distributed cloud computing environment (private cloud, public cloud, community cloud, and/or hybrid cloud), an on-premise environment, fog computing environment, and/or an edge computing environment. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a global positioning system device (GPS) configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components, either directly or indirectly—by way of intermediate component(s)-with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non- limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (SaaS). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third and fourth party systems such as merchant systems configured to interact with the user device 106 during transactions and also configured to interact with the enterprise system 200 in back-end transactions clearing processes.

In certain embodiments, one or more of the systems and devices, such as the user device (referring to either or both of the computing device 104 and the mobile device 106), the enterprise system 200, and/or the external systems 202 and 204 are, include, or utilize virtual resources. In some cases, such virtual resources are considered cloud resources or virtual machines. The cloud computing configuration may provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

The above-described devices and systems facilitate implementing reusable user interface (UI) components, in some embodiments. Once constructed, the user interface components can be used in various programs and applications, being available for example in an open-source library. High-level utility is found at least in time savings for program development and brand identification as proprietary design specifics are shared among software coders and developers of an enterprise entity. At the functional level, each example described here and those that come to mind in view of these descriptions serve specific functions for both user and developer convenience.

Consistency in choices of interface elements fosters user familiarity, providing elements acting in a particular way. Choosing to adopt consistent elements can help on both the enterprise side and user side with task completion, efficiency, and satisfaction.

Typical interface elements include, but are not limited to, input controls, navigational components, and information components. Typical input controls include, but are not limited to, checkboxes, radio buttons, dropdown lists, list boxes, buttons, toggles, text fields, and date field. Typical navigational components include, but are not limited to breadcrumbs, sliders, search fields, paginations, tags, and icons. Typical informational components include, but are not limited to, tooltips, icons, progress bars, notifications, message boxes, and modal windows. These terms delineating, for descriptive purposes, typical interface elements as input controls, navigational components, and information components are offered here for an understanding of context and use of the described inventive embodiments, without limiting those embodiments to such characterizations. In some cases an interface element may be characterized as more than one these types, such that not all such characterizations will be universally agreed upon, and in some cases, these terms may be used interchangeably.

The inventive interface elements described herein can be characterized as well as design system tokens, which implement style values of UI elements, values that govern color, typography, spacing, shapes, shadows, and the like. Once established, the token can be used across products and are capable of being converted or mapped into the format for any platform (web, angular, mobile, desktop, IOS, Android, etc.). Tokens can be taken by front end developers in referencing things within a design system and automatically inserted into or utilized by front end code. Tokens allow for keeping consistency through an app delivering things without having to do updates within the app side code for development.

Within a company, for example, a design system improves collaboration between product teams. A common challenge design and engineering teams are facing is the sharing of brand guidelines and interface information across the institution they serve. Designs once developed should be respected for efficiency and consistency. Product teams need guidelines to ensure brand consistency. This is where style guides and pattern libraries come into play, as implemented by tokens in some cases.

An advantageous aspect of inventive interface elements described herein regards compatibility and with screen readers, which are software programs that allow blind or visually impaired users to read text that is displayed on a screen with, for example, a speech synthesizer or braille display. A screen reader serves as an interface between the computer's operating system, its applications, and the user. Commands are sent by the user pressing key combinations on the keyboard or braille display to prompt the synthesizer and/or braille display what to say and/or output automatically when changes do or would otherwise occur on a computer screen. A command can instruct the synthesizer and/or braille display to read or spell a word, read a line or full screen of text, find a text string, announce the location of a cursor or focused item, and so on. Users can perform advanced functions, such as locating items such as text and/or icons displayed in any particular color, indicating a color change, and reading pre-designated parts of a screen on demand, reading highlighted text, and identifying an active choice in a menu. Users may also use a spell checker or read the cells of a spreadsheet with a screen reader or braille display. Screen readers are currently available for use with personal computers running Linux, Windows, and Mac, IOS, Android, and more, and the inventive interface elements described herein are compatible and configured for use with same.

The above-described devices and systems facilitate an accumulator tool implemented in corresponding devices, systems, and methods, with functions including that of a combo box, which combines, in some embodiments, the benefits of a drop down list or list box, and an editable textbox. Items are listed for selection by a user. Multiple items can be selected. These descriptions detail inventive and advantageous features by which the selection of multiple items can be managed, for example when lengthy lists of items are to be presented for possible selection. As items are selected, corresponding tags, each in one-to-one correspondence with a particular selected item, are accumulated and displayed in an accumulation area for ready identification. This advantageously informs a user of what selections have been made without necessitating, for example, needlessly repetitive user attention to the list, which may be lengthy and may extend beyond immediate view in any display, for example where a scroll tool is used.

Inventive embodiments of a tag accumulator tool described herein can be transitioned between expanded and reduced modes thereof. For example, in at least one embodiment of a tag accumulator tool in an expanded mode, a proffered dataset of multiple data items is displayed. In at least one embodiment of a tag accumulator tool in a reduced mode, a display thereof includes an enumeration of the selected items and/or a cache of tags each representing a respective selected item.

Many types of datasets may be proffered. The multiple data items in a proffered dataset may correspond to functions, tools, files, folders, subjects, actions, activities, items for sale, items for use, services, names, accounts, payments, vendors, locations, addresses, and more. Selected items may correspondingly be subject to, subjects of, and/or involved in further activity and/or processing according to the context and use of the combo box and/or tag accumulator tool, which can vary. The selected items identified by corresponding tags in the accumulated tag cache may be subjects of or subjected to billing activities, including disbursements and/or requests for payment.

For example, the proffered dataset may include previously established and/or currently available billing payment recipients for the convenience of a consumer intending to make online payments for purchases, utilities, subscriptions, services, insurance, a mortgage, an automobile loan and other purposes. The proffered dataset may include previously established and/or currently available customers or other payers for the convenience of a business or other payee intending to receive online payments for purchases, utilities, subscriptions, services and other purposes.

The selected items identified by corresponding tags may be forwarded into a database, a search function, a communication, a document, and/or a program. The datasets proffered may be previously chosen by the same or other user, and may be selected by human action, by automated categorization, by artificial intelligence, and any combination of these modes.

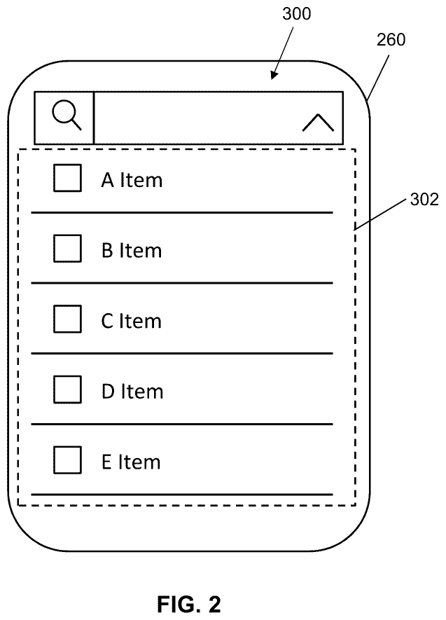

FIG. 2 shows a display 260 of an accumulator tool 300 according to at least one embodiment. The display 260 represents, in various examples and with reference for example to FIG. 1 as well, the display 140 of a user mobile device 106, the display of a user computing device 104, and the display of an agent device 212, each one of which and other examples as well can be termed as a computing device. Thus a user thereof in some examples is represented in FIG. 1 as user 110, as an agent 210, or as another party or entity.

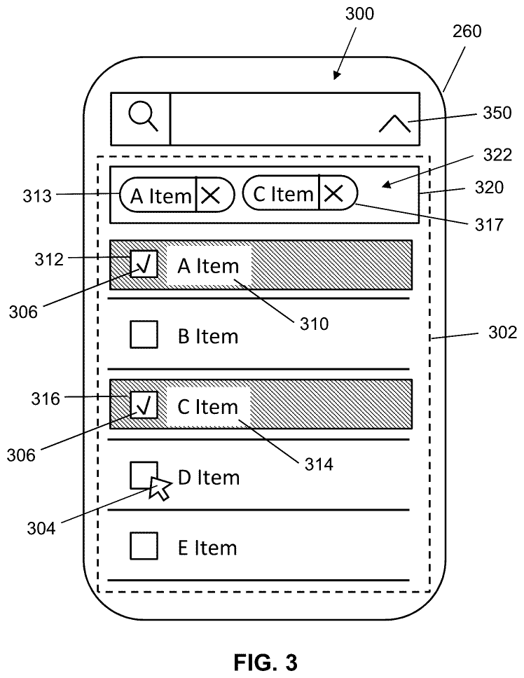

The accumulator tool 300 is shown in an expanded mode thereof, in which a proffered dataset 302 is displayed as a list including multiple data items, none of which are shown as selected in FIG. 2. User input is enabled, for example via various input devices as described above with reference to FIG. 1. In FIG. 3, user input is illustrated in part as navigation of a marker 304 which represents a cursor, a finger touch position, and a stylus position in various examples. Each data item is shown with a respective graphical indicator, which transitions visually upon selection of the associated data item. In the illustrated example, the graphical indicators are illustrated as boxes, which are populated by a symbol 306, shown in particular as a check mark as a non-limiting example, upon selection of their respective data item by user action. Two particular data items of the proffered dataset 302 are selected in FIG. 3 as represented by check marks in their respective graphical indicators. In the illustrated example, a first item 310 shown as “A item” is indicated as selected by the respective first indicator 312, and a second item 314 shown as “C item” is indicated as selected by the respective second indicator 316. These selections are further indicated in the illustrated example by respective shaded areas around the data items, representing any mode of emphasizing, highlighting, or otherwise indicating selection.

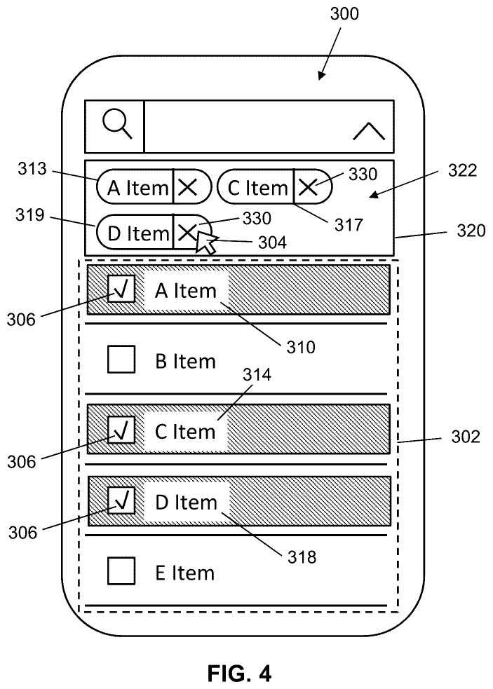

The tag accumulator tool 300 includes an accumulation area 320 in which a tag cache 322 is displayed. The tag cache 322 incudes a respective tag in correspondence with each selected data item. As shown in FIG. 3, in which the first item 310 (“A item”) and second item 314 (“C item”) are each selected, a first tag 313 corresponding to the first item 310 and a second tag 317 corresponding to the second item 314 are shown in the accumulation area 320 indicating their selection. Further user action can further populate the accumulation area 320, for example as represented in transitioning from FIG. 3 to FIG. 4 upon user action selecting a third item 318 shown as “D item,” noting that the third tag 319 corresponding to the third item 318 appears in the tag cache 322 in FIG. 4.

In the illustrated examples, each tag in the tag cache 322 includes an annul tool 330, the activation of which removes the respective tag from the accumulation area 320. This is represented in transitioning from FIG. 4 to FIG. 3, upon user action on the annul tool 330 of the third tag 319, as represented by the marker 304. The annul tool 330 effectively, when activated, returns the corresponding data item to an unselected status.

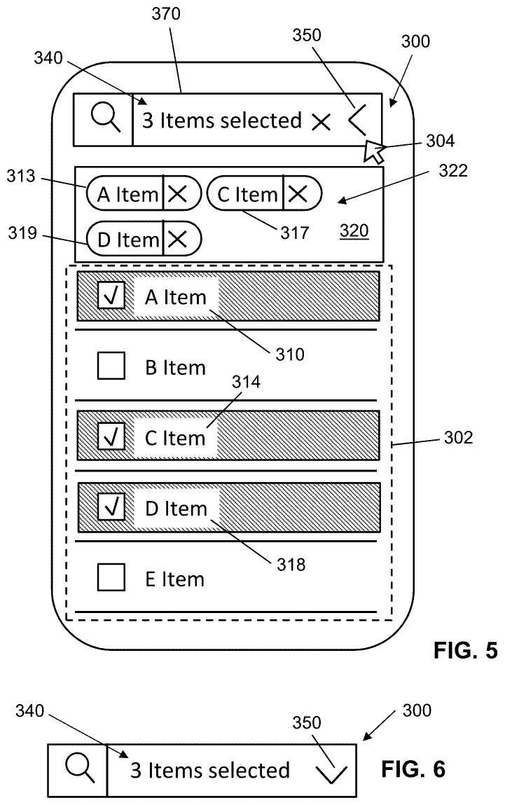

In some embodiments, the tag accumulator tool 300 includes an enumeration 340 of selected data items. For example as shown in FIG. 5, three data items are selected (the first item 310, the second item 314, and the third item 318), three the corresponding tags (the first tag 313, the second tag, 317 and the third tag 319) are shown in the tag cache 322 in the accumulation area 320, and accordingly an enumeration 340 of the selected data items is shown as “3 items selected.” The enumeration 340, such as a counting of the number of selected data items, can be represented in character form as a number, a term, or a symbol in various examples.

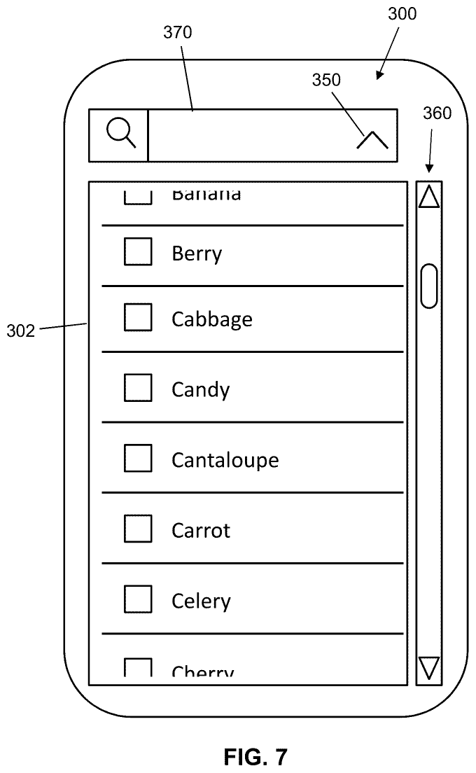

The tag accumulator tool 300, in some implementations, includes an operable toggle indicium 350, by which, upon user action thereon, the display of the tag accumulator tool 300 transitions between an expanded mode, as in FIGS. 2-5, and a reduced mode, as in FIG. 6. In the expanded mode, the tag accumulator tool 300 includes display of a proffered dataset 302 including multiple data items and the accumulation area 320 with the tag cache 322 therein. The proffered dataset 302 is displayed at least in part in the expanded mode, noting that in some examples and uses, a proffered dataset 302 may be lengthy and may extend beyond immediate view in any display, for example such that a scroll tool 360 can be used (FIG. 7) to navigate the entire list. The data items of the proffered dataset 302 may be listed in a convenient order. In the illustrated examples, the data items are listed in alphabetical order. Other non-limiting examples include ordering data items in a numeric order, in an order of relevance, in an order of chronology such as date entered or modified, and in an order of size by any preferred metric.

In the illustrated examples, the operable toggle indicium 350 is shown as a chevron symbol (V-shaped). In the expanded mode of the tag accumulator tool 300, activation of the toggle indicium 350, as represented by the marker 304 in FIG. 5, transitions the tag accumulator tool 300 to a reduced mode, an example of which is shown in FIG. 6. Conversely, in the reduced mode of the tag accumulator tool 300 in FIG. 6, activation of the toggle indicium 350 transitions the tag accumulator tool 300 to the expanded mode shown in FIG. 5.

In the reduced mode of the tag accumulator tool 300 shown in FIG. 6, an enumeration 340 of the selected data items is shown as “3 items selected” without the proffered dataset, and without the accumulation area. In other examples of reduced modes, the enumeration 340 of the selected data items is shown without the proffered dataset, and with the accumulation area to show the tag cache for ready identification of selected items.

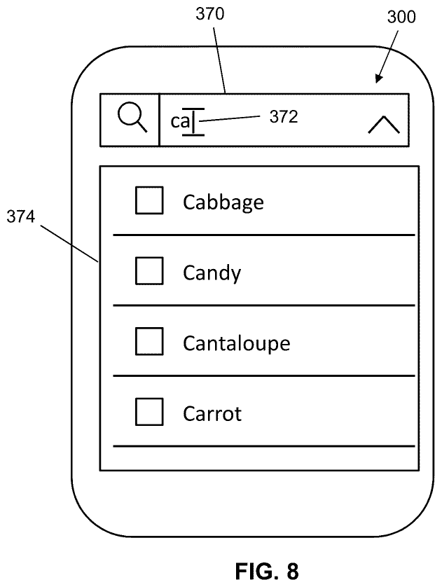

FIGS. 7-9 illustrate an exemplary use of the tag accumulator tool in which a proffered dataset 302 is lengthy and extends beyond immediate view in any display, for example such that a scroll tool 360 can be used (FIG. 7) in an expanded mode in which no filter is applied. To facilitate user handling of lengthy proffered datasets, the tag accumulator tool 300 includes a query box 370. The above descriptions reference an enumeration 340 of selected data items and an operable toggle indicium 350, both of which appear in the query box 370 in the illustrated examples. Upon user entry of characters in the query box, as represented by the text cursor 372 in FIG. 8, a filter is applied to the data items of the proffered dataset 302 that are shown in the display. As a character string is typed or otherwise entered into the query box, a redacted list of 374 selectable items is displayed, the redacted list 374 (FIG. 8) of selectable items including only those multiple data items of the proffered dataset 302 (FIG. 7) at least partially matching the character string. Typing or other entry of a character string, which can include one character or any number of characters, into the query box 370 supersedes the enumeration in the illustrated examples.

In the illustrated example of FIG. 7, in which a lengthy proffered dataset 302 is partially viewable according to the position of a tab 362 of the scroll tool 360, multiple data items are listed alphabetically. Upon entry of the character string “ca” into the query box 370 as in FIG. 8, a redacted list 374 of selectable items is shown including only those having in the spelling the entered character string, thus at least partially matching the character string. Matching in various examples refers to exact matches, approximate matches, first characters in a data item matching a character string, last characters in a data item matching a character string, intermediate characters in a data item matching a character string, synonym matching, date or date range matching, file type matching, author matching, or other file contents or file metadata matching.

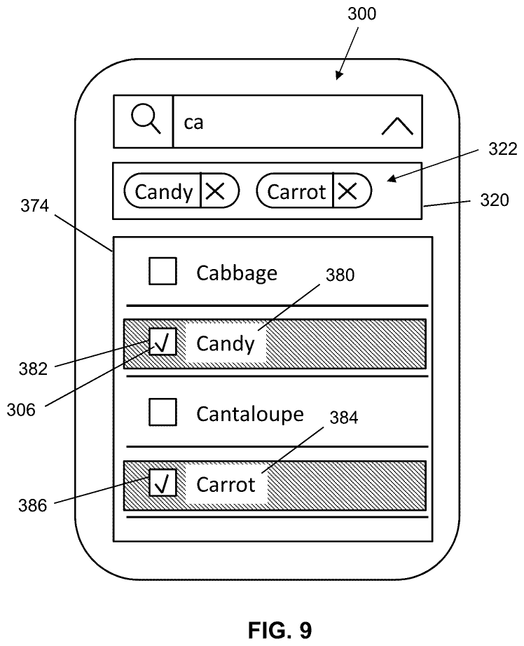

As represented in FIG. 9, previously described functions and feature of the tag accumulator tool 300 remain available for use when a character string is present in the query box 370. For example, data items of the redacted list 374, which are filtered according to at least partially matching the character string(“ca”), can be selected to populate the accumulation area 320. In the illustrated example, a first redacted list item 380 shown as “Candy” is indicated as selected by the symbol 306 present in the respective graphical indicator 382. Similarly, a second redacted list item 384 shown as “Carrot” is indicated as selected at the respective graphical indicator 386. These selections are further indicated in the illustrated example by respective shaded areas around the selected data items. Furthermore, in keeping with above-described features and advantages of the tag accumulator tool 300, the accumulation area 320 in which a tag cache 322 is displayed includes a respective tag in correspondence with each selected data item.

Thus systems, devices, and methods are described herein for improved functioning of computer systems and networks by reducing time of use of combo boxes and related tools and functions by which or instead of which the above-described tag accumulator tool can be used. Thus latencies and power consumption are reduced and machine and network efficiencies are improved. By use of the above-described tag accumulator tool, a user is conveniently informed of what selections have been made without necessarily scrolling an entire list and counting how many are selected. A user can conveniently view the tag cache and enumeration, and, if desired the user can use the annul tools to unselect any items at will without relocating the associated data items in the proffered dataset fully listed.

According to the above descriptions, in various embodiments and for at least one example, the system 200 provides for accumulating a tag cache from a proffered dataset. In at least one other example, devices represented in FIG. 1 as user devices 104 and 106 serve in conjunction with and/or independently from the system 200 for accumulating a tag cache from a proffered dataset.

In non-limiting examples, the system 200 may be that of an entity that provides financial services and operates as a financial institution. The first entity may be engaging a user in a range of services such as checking, credit card, debit card, mortgage, and savings account services. In such cases, a proffered dataset can regard any number of products and services. The proffered dataset can regard account data, options, and records regarding credit cards, checking, savings, and other financial arrangements and means.

At least one of a memory device 222 and a non-transitory storage device 224, in some embodiments, maintains account records for each of multiple registered users, each having at least one user device. The network connection 258 can operatively connect the computing system 206 to the user devices of the multiple registered users, with reference as non-limiting examples to user 110 and devices represented in FIG. 1 as user devices 104 and 106. The tag accumulator tool 300 described and illustrated herein may be effectively seen as a display output on a user device from a software program or portion thereof running on the enterprise side, with reference to system 200 and the processing device 220, such that the system 200 at least in part remotely controls or contributes to a display at a user device across a network. The display of the tag accumulator tool 300 and its functions can be effected using a design system token, for example which may be available system-wide, referring to the enterprise system 200, in a source library 240 (FIG. 1) where various programs and applications are available to administrators, agents, and the computing systems 206. The design system token described and/or other software implementations of the tag accumulator tool 300 described herein is in some examples compatible with screen readers for outputting to a speech synthesizer or braille display.

In some embodiments, the tag accumulator tool 300 is effected by a software program or portion thereof running and/or available at external systems 202 and 204 (FIG. 1). In yet other embodiments, the tag accumulator tool 300 is effected by a software program or portion thereof running on a user device. For example, a design system token or other software program or code may be stored upon and disseminated from the library 240 and/or other libraries, folders, or files resident at user devices and/or external systems.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A computing device for accumulating a tag cache from a proffered dataset, the computing device comprising:
at least one processor;
a communication interface communicatively coupled to the at least one processor; and
a memory device storing executable code that, when executed, causes the processor to:
initiate a tag accumulator tool by at least displaying, in an expanded mode of the tag accumulator tool, a proffered dataset comprising multiple data items;
receive user input selecting one or more of the multiple data items;
display an accumulation area comprising a tag cache comprising, for each one of the selected data items, a respective corresponding tag; and
display, in at least a reduced mode of the tag accumulator tool, an enumeration of the selected data items.

2. The computing device according to 1, wherein, in the expanded mode of the tag accumulator tool and in the reduced mode of the tag accumulator tool, a display of the tag accumulator tool comprises a query box operable to, upon entry of a character string into the query box, display a redacted list of selectable items, the redacted list of selectable items including only those multiple data items of the proffered dataset at least partially matching the character string.

3. The computing device according to 1, wherein, in the expanded mode of the tag accumulator tool and in the reduced mode of the tag accumulator tool, the display of the tag accumulator tool comprises an operable toggle indicium, by which, upon user action thereon, the display of the tag accumulator transitions between the expanded mode and the reduced mode.

4. The computing device according to claim 1, wherein a design system token is used to initiate display of a tag accumulator tool.

5. The computing device according to claim 4, wherein the design system token is compatible with a screen reader for outputting to a speech synthesizer or braille display.

6. The computing device according to claim 1, wherein each respective corresponding tag comprises an annul tool the activation of which removes the respective corresponding tag from the accumulation area.

7. The computing device according to claim 1, wherein the proffered dataset comprises multiple displayed data items and additional data items displayed upon use of a scroll tool.

8. A system for accumulating a tag cache from a proffered dataset, the system comprising:
at least one processor;
a communication interface communicatively coupled to the at least one processor;
a memory device storing executable code that, when executed, causes the processor to:
transmit to a user device instructions to initiate a tag accumulator tool by at least displaying, in an expanded mode of the tag accumulator tool, a proffered dataset comprising multiple data items;
receive, from the user device, input selecting one or more of the multiple data items;
transmit to the user device instructions to display an accumulation area comprising a tag cache comprising, for each one of the selected data items, a respective corresponding tag; and
transmit to the user device instructions to display, in at least a reduced mode of the tag accumulator tool, an enumeration of the selected data items.

9. The system according to 8, wherein, in the expanded mode of the tag accumulator tool and in the reduced mode of the tag accumulator tool, a display of the tag accumulator tool comprises a query box operable to, upon entry of a character string into the query box, display a redacted list of selectable items, the redacted list of selectable items including only those multiple data items of the proffered dataset at least partially matching the character string.

10. The system according to 8, wherein, in the expanded mode of the tag accumulator tool and in the reduced mode of the tag accumulator tool, the display of the tag accumulator tool comprises an operable toggle indicium, by which, upon user action thereon, the display of the tag accumulator transitions between the expanded mode and the reduced mode.

11. The system according to claim 8, wherein a design system token is used to initiate display of a tag accumulator tool.

12. The system according to claim 11, wherein the design system token is compatible with a screen reader for outputting to a speech synthesizer or braille display.

13. The system according to claim 8, wherein each respective corresponding tag comprises an annul tool the activation of which removes the respective corresponding tag from the accumulation area.

14. The system according to claim 8, wherein the proffered dataset comprises multiple displayed data items and additional data items displayed upon use of a scroll tool.

15. A method for a computing system to accumulate a tag cache from a proffered dataset, the computing system including one or more processor, and at least one memory device storing computer-readable instructions, the one or more processor configured to execute the computer-readable instructions, the method comprising, upon execution of the computer-readable instructions:
initiating a tag accumulator tool by at least displaying, in an expanded mode of the tag accumulator tool, a proffered dataset comprising multiple data items;
receiving user input selecting one or more of the multiple data items;
displaying an accumulation area comprising a tag cache comprising, for each one of the selected data items, a respective corresponding tag; and
displaying, in at least a reduced mode of the tag accumulator tool, an enumeration of the selected data items.

16. The method according to 15, wherein, in the expanded mode of the tag accumulator tool and in the reduced mode of the tag accumulator tool, a display of the tag accumulator tool comprises a query box operable to, upon entry of a character string into the query box, display a redacted list of selectable items, the redacted list of selectable items including only those multiple data items of the proffered dataset at least partially matching the character string.

17. The method according to 15, wherein, in the expanded mode of the tag accumulator tool and in the reduced mode of the tag accumulator tool, the display of the tag accumulator tool comprises an operable toggle indicium, by which, upon user action thereon, the display of the tag accumulator transitions between the expanded mode and the reduced mode.

18. The method according to 15, wherein a design system token is used to initiate display of a tag accumulator tool.

19. The method according to 18, wherein the design system token is compatible with a screen reader for outputting to a speech synthesizer or braille display.

20. The method according to 15, wherein each respective corresponding tag comprises an annul tool the activation of which removes the respective corresponding tag from the accumulation area.
